(19) United States
(12) Patent Application Publication
(10) Pub. No.: US 2024/0370671 A1
(43) Pub. Date: Nov. 7, 2024

(54) Personalized (Non-standard) Voice Recognition System Software

(71) Applicant: Xinyao Ding, Markham (CA)

(72) Inventor: Xinyao Ding, Markham (CA)

(21) Appl. No.: 18/772,122

(22) Filed: Jul. 13, 2024

Related U.S. Application Data
(60) Provisional application No. 63/655,133, filed on Jun. 3, 2024.

(51) Int. Cl. G06F 40/58; G10L 15/06

(52) U.S. Cl. CPC G06F 40/58; G10L 15/063

(57) ABSTRACT

This is a translation software that can accurately translate various languages, dialects and voices with personal accents in the world into standard voices and texts of any target language (such as standard English, Japanese, etc.), and then translate them into voices with their own pronunciation characteristics that any individual can understand.

### FIELD OF INVENTION

This is an invention in the field of software development. The software can accurately recognize and translate the special and personalized speech that people say in daily life, which is difficult for others to understand, into standard speech that people can understand, and further translate this standard speech into speech with the other party's personal speech characteristics that the other party can understand. The recognition accuracy of this translation software is high. It will replace the current translation software that can only translate standard speech (such as standard English and Japanese) into other standard speech (such as German and French) and has low translation accuracy. This software fills the gap in the field of voice translation software. It greatly improves the application field of people's special speech and the adaptability of special speech. This translation software and its extended functions will play a huge role in the future barrier-free voice communication of human beings and the future voice dialogue between people and intelligent machines.

### BACKGROUND OF THE INVENTION

Existing translation tools and software technologies usually rely on standard language recognition and translation models, which can only handle the mutual translation of languages such as English, Japanese, and Mandarin Chinese with standard pronunciation. Here I call them standard language translation software and tools. These tools cannot effectively handle personalized pronunciations, such as unique pronunciations with dialects and accents.

Due to the large population of the world, everyone has their own unique pronunciation and accent characteristics. Many people speak non-standard voices or special personalized voices that cannot be recognized and processed by the standard language recognition system in the current standard language translation software and tools. For example, the pronunciation of residents who speak dialects in a certain state in the United States, or different groups such as Indians and Eskimos, often differs greatly from the pronunciation of standard languages. The current standard voice translation tools have obvious limitations in processing these non-standard pronunciations, lack the adaptability to individual pronunciation characteristics, and have extremely low accuracy in recognizing and translating personalized pronunciations. This is the main reason why existing voice translation software and tools cannot be widely used or popularized.

[symbol] [symbol] samples) to achieve accurate recognition of new individual data (this step is not available in existing translation software and is also the core of this software's wide use and popularization); convert the recognized voice into the standard voice of the user's country language, and then translate it into the standard voice output of any target language.

The software realizes the reversibility of the above steps, that is, the software converts the standard voice translation of any target language (such as English, Mandarin Chinese) into the pronunciation of the user's native language with its own language characteristics, such as: the dialect spoken by the customer and the pronunciation with its own voice characteristics. (The principle and method of realizing this reversible process are consistent with the principle of the above forward realization).

### DETAILED DESCRIPTION OF THE INVENTION

### Core Concept:

This invention is a special voice translation software that has a completely different working principle from all the existing translation software on the market. The software can accurately translate various languages, dialects and voices with personal accents in the world into standard voices and texts (such as standard Mandarin, standard English, etc.) of any target language, and then translate them into the required voices with their own dialects and pronunciation characteristics that any individual can understand.

### AI Algorithm:

This personalized voice translation software uses artificial intelligence training models, repeatedly trains and optimizes parameters of voice samples formed on the basis of a large number of text samples provided by individual users, and uses AI algorithms to extract features from the user's pronunciation, such as pitch, frequency, rhythm, unique pronunciation of words and sentences, etc., and maps them to corresponding text texts to improve the recognition accuracy of new data (new voice content of individuals that is different from samples) to achieve accurate recognition of individual new data; convert the recognized voice into the standard voice of the country language spoken by the person (or the text of the country language, or a string of computer languages that the software can recognize itself, because this step is an intermediate process of software translation and does not need to be presented to customers, so the form of conversion depends on the convenience of software design); translate the standard voice into any required standard voice output in the target language, or further convert the standard voice (or text) into voice output with user personality characteristics.

### Specific Steps:

Users can use the model training guidance methods and teaching materials provided by the software and software companies to conduct a large amount of model training through the following steps: prepare voice samples and corresponding text, users read specific text content, record and save these voice samples, ensure that the voice samples are clear, and each voice sample has a corresponding text. Import the voice sample and the corresponding text data into the software. Make sure that the imported data format meets the software requirements. Note: The above steps can also be improved and combined into the following steps: The text can also be installed in the software in advance, and the software can be installed in a device with a screen that can display text, such as a mobile phone, to achieve a one-time matching of voice and text and import into the software.

### Model Training:

Use the model training guidance and teaching materials provided by the software to set the training parameters of the model. Start the training process, and the software will use AI algorithms to extract features from the user's voice samples, such as pitch, frequency, rhythm, etc., and map them to the corresponding text for repeated training.

### Model Evaluation and Adjustment:

After the training is completed, use some new voice samples to evaluate the model (the text corresponding to these voice samples can also be installed in the software in advance) to check the recognition accuracy. According to the evaluation results, adjust the training parameters or add new voice samples for further training.

### Complete Model Training:

Through this repeated training, the software can recognize and understand new voice content (new data) spoken by the user's unique pronunciation.

### Establish an Application Model to Recognize the Voice:

At the same time, the software also generates a recognition module that belongs to the customer and can recognize personalized voice. Each user can not only install this software module on his own mobile phone (or other smart device), but also migrate and install the module on different devices with this software installed to facilitate the human-computer (artificial intelligence or robot) dialogue mentioned later.

### Use Software to Translate and Output:

Convert the recognized personalized voice into standard voice or text in multiple target languages (such as English, Mandarin Chinese). Then output this standard voice (or text). The software can realize single output or simultaneous output of standard voice (or text) in multiple target languages (such as: English, Japanese, German, etc.) for translation in different occasions. The software realizes the reversibility of the above steps, that is:

The software can translate the standard voice of any target language (such as English, Mandarin Chinese) into the personalized voice of the user in the target language used by the user (such as English, but English with the user's accent). This allows customers to choose whether to directly accept the standard pronunciation of their own language or the pronunciation of their own language characteristics, such as: the dialect spoken by the customer and the pronunciation with their own voice characteristics. (The principles and methods for achieving this reversible process are consistent with the principles of the above forward implementation).

### Continuous Optimization:

Furthermore, as users continue to use the software, while translating and outputting their own voices into standard voices in other target languages, the software will further obtain many user language pronunciation characteristics and voice habit characteristics. The software will use these continuously accumulated samples to continue to train the user's voice model to improve the prediction of the user's voice and thinking, and ultimately make the software's translation more accurate and faster, achieving the effect of translating and outputting the user's voice simultaneously.

### Software Includes Main Functional Modules

Special speech recognition module: It includes four main models: 1) Special speech acquisition model; 2) Special speech training model; 3) Speech model evaluation and adjustment model; 4) Recognition model after special speech data training is completed

Module for converting special speech recognition into standard speech (or text) in the language you use

Module for translating standard speech (or text) in your own language into standard speech in the target language

Module for converting standard speech in the target language into special speech in the target language

Speech reception and distribution model of the central translation device

### Software Application Operation Process

Special voice collection

Special voice training

Voice model evaluation and adjustment

Establish special voice recognition module

Convert special voice recognition into standard voice of the language you use

Translate the standard voice (or text) of your language into standard voice output of the target language

Accept the standard voice of the target language and convert the standard voice into special voice of the language.

### Software Application Scenarios

Barrier-free communication between two people

Face-to-face voice communication: Users can use devices with the software installed to translate their own unique voices into the other party's standard language and achieve barrier-free communication through the device.

Long-distance calls: Both parties use devices with the software installed to make voice or video calls. The software translates each other's unique voices into the standard voice required by the other party, and then the software in the other party's device converts it into personalized voice for listening.

Barrier-free communication between multiple people

Central translation device: The software's two-person translation communication principle is extended to multi-person translation. The specific operation is similar to two-person communication, but the voice data is managed and distributed through the central device.

Face-to-face voice communication 1: The user connects his mobile phone (or other smart device, such as a computer, robot, etc.) with the software installed to the central translation device through wired or wireless means. The speaking customer transmits the file that has been converted from the characteristic voice to the standard voice (such as standard English voice) to the central translation device, and the central translation device distributes the standard voice file to each other customer's mobile phone (or other smart device, such as a computer, robot, etc.); each customer then translates the standard language back to the characteristic voice that he can understand through the software in his mobile phone, thereby realizing multi-language barrier-free communication in meetings of various sizes.

Face-to-face voice communication 2: Without connecting to the customer's mobile phone (or other smart devices, such as computers, etc.), before the meeting starts, each customer inputs his or her own “characteristic voice conversion to standard voice” model and “standard voice conversion to characteristic voice model” into the central translation device equipped with the software that can accept user voice modules. The device can have its own audio input and output device (wired or wireless) headphones. Afterwards, the user does not need to use his or her own mobile phone (or other smart devices, such as computers, etc.), and can directly use the central translation device for face-to-face calls.

Human-machine interaction:

Install the user's personalized voice recognition module into smart devices (such as AI robots, smart home devices, your own smart aircraft, cars, etc.) to achieve effective communication between human and machine voice.

### Additional Software Features

Animal language translation: Translate animal calls into human language by training animal voice models.

Sign language translation: Recognize gestures, body language and micro-expressions, and convert them into text or voice.

Future expansion: Future applications include translating alien languages or combining advanced emotions and contextual understanding to achieve more delicate communication.

### Drawing Description

Since the functions that drawings can help express in this invention are not obvious, they are not used here.

### Future Application Prospects

As artificial intelligence and machines continue to improve their training technology and speed through big data learning, they will have broad application prospects in many fields in the future. For example, voice interaction between people and robots will rely extensively on this software. Whether it is a home robot, a service robot, or an industrial robot, by installing this software, barrier-free communication with users can be achieved. In the future, any smart device that needs to process voice interaction will need to integrate this software to enhance the intelligence of the device and user experience.

### Additional Notes

Due to the rapid development of artificial intelligence model algorithms, software engineers or software development companies can easily implement and integrate the functions and translation functions mentioned here into the software. My invention focuses on providing ideas and thoughts for software development, and many software development companies are currently capable of implementing the specific technologies of how to use AI algorithms inside the software, how to let the model train itself, generate personalized voice recognition modules and integrate these modules. I don't involve much technology developed inside the software here. I provide more ideas for software development and use, software functions, applications in different occasions, market prospects and value, etc. This is a special voice recognition and voice translation software that will be used in almost any occasion where voice communication is required in the future. It will have an unlimited market prospect.

1. A special voice translation software, characterized in that it can recognize and translate personalized voice pronunciation into standard language (text or voice) and output it through artificial intelligence training model, using voice samples and text data provided by users for repeated training.

2. The voice translation software as claimed in claim 1 can further translate the standard language back into voice functions with user personality characteristics.

3. The voice translation software as claimed in claim 1 or 2 is characterized in that the software and its trained special voice recognition model are installed on mobile phones, computers, central translation tools, intelligent robots and other devices to achieve barrier-free communication between users in multiple scenarios.

4. The voice translation software as claimed in any one of claims 1 to 3 is characterized in that it can be applied to future users and various intelligent devices and robots that require voice dialogue and realize barrier-free voice interaction between users and intelligent robots and all intelligent devices.

5. The voice translation software as claimed in any one of claims 1 to 4 is characterized in that it can understand the calls of animals through training and learning and translate them into human standard language.

6. The voice translation software as claimed in any one of claims 1 to 5 is characterized in that it can recognize and translate sign language, body language, and micro-expressions.

7. The speech translation software as described in any one of claims 1 to 6 is characterized in that it can be further expanded to translate any language (including alien languages that do not require telepathy) and more advanced emotion and context understanding.
